(19) United States
(12) Patent Application Publication
(10) Pub. No.: US 2026/0072751 A1
(43) Pub. Date: Mar. 12, 2026

(54) Edge-Based Process Monitoring for an Observability Pipeline System

(71) Applicant: Cribl, Inc., San Francisco, CA (US)

(72) Inventors: Dritan Bitincka, Edgewater, NJ (US); Ledion Bitincka, San Francisco, CA (US); Paul Avery Dugas, Canton, GA (US)

(73) Assignee: Cribl, Inc., San Francisco, CA (US)

(21) Appl. No.: 18/882,406

(22) Filed: Sep. 11, 2024

(51) Int. Cl. G06F 9/50

(52) U.S. Cl. CPC G06F 9/505

(57) ABSTRACT

In some aspects, an edge-based data collection system discovers, collects, processes, and forwards data in an observability pipeline system. In some implementations, an edge agent of the observability pipeline system runs on a computer node. The edge agent receives a process discovery filter configured to identify target processes running on computer nodes, selects one or more matching target processes by applying the process discovery filter, monitors activity of the one or more matching target processes, and processes the activity data to generate output data representing the activity of the one or more matching target processes. In some aspects, monitoring the activity includes collecting activity data corresponding to monitored activity of the one or more matching target processes using one or more of the following monitoring sources: monitoring of system calls made by a respective process; monitoring via a system information kernel interface; monitoring using eBPF; and monitoring using function interposition.

### BACKGROUND

The following description relates to edge-based process monitoring for an observability pipeline system.

Observability pipelines are used to route and process data in a number of contexts. For example, observability pipelines can provide unified routing of various types of machine data to multiple destinations, while adapting data shapes and controlling data volumes. In some implementations, observability pipelines allow an organization to interrogate machine data from its environment without knowing in advance the questions that will be asked. Observability pipelines may also provide monitoring and alerting functions, which allow systematic observation of data for known conditions that require specific action or attention.

### BRIEF DESCRIPTION OF THE DRAWINGS

FIG. 1 is a block diagram showing aspects of an example computing environment.

FIG. 2 is a block diagram showing aspects of an example data processing engine.

FIG. 3 is a flow chart showing aspects of an example process performed by an edge agent of an observability pipeline system.

FIGS. 4A-4B are schematic diagrams showing aspects of example computer nodes of an observability pipeline system.

FIG. 5 is a block diagram showing an example computer system.

### DETAILED DESCRIPTION

In some aspects of what is described here, target processes on a computer node are discovered and selected for monitoring, and activity data for the monitored processes is collected and processed by operation of an edge-based data collection system. In some implementations, the edge-based data collection system operates as an edge agent on a computer node or another type of data source in a computing environment. For example, the edge-based data collection system may operate on a computer device or system where processes run and data originates in a network (e.g., a server, server cluster, a Raspberry Pi device, a PC, a smart device, etc.).

In some cases, the edge-based data collection system includes edge agents of an observability pipeline system installed on multiple end-point devices or other types of computer nodes. In some cases, the edge-based data collection system provides a user interface that allows a user to customize what types of processes are to be monitored by the observability pipeline system. In some cases, the edge-based data collection system may further discover the processes and extract data from the discovered processes. The discovered processes may be added to a list which includes processes to be monitored by the observability pipeline system. In some cases, the user interface of the edge-based data collection system may further allow a user to customize how the activity data are collected from target processes. In some cases, activity data can be collected by monitoring system calls made by a target process, by monitoring using a system information kernel interface, by monitoring using eBPF, or by monitoring using function interposition. Based on the collected activity data, the edge-based data collection system generates output data representing activity of the target processes. In some cases, the generated output can be used as observability pipeline input data for further processing in the observability pipeline system. In some cases, the edge-based data collection system can route output data from the monitored activity to data destinations (e.g., a data storage or a user device).

In some implementations, the methods and techniques presented here can provide advantages over existing technologies. For example, an edge-based data collection system can be used for microservice architectures and sprawling environments. The edge-based data collection system may collect, process, and forward data with flexibility and low resource overhead. The edge-based data collection system may have a low cost of ownership, and may be scalable and centrally managed, configured, and version controlled for easy expansion. The edge-based data collection system can be user-experience oriented, for example, allowing users (e.g., through a user interface) to specify process discovery parameters for filtering and selecting processes; to specify and optimize data collection parameters for obtaining activity data from the selected processes; to obtain information about collected data; and to perform pre-processing to the collected data. In some cases, an edge-based data collection system provides a highly differentiated single node experience. The edge-based data collection system can serve as a stepping stone for distributed user experience. In some implementations, an edge-based data collection system is easy to configure, setup and get started; can provide management at scale; and balance performance and resource utilization. In some cases, a combination of these and potentially other advantages and improvements may be obtained.

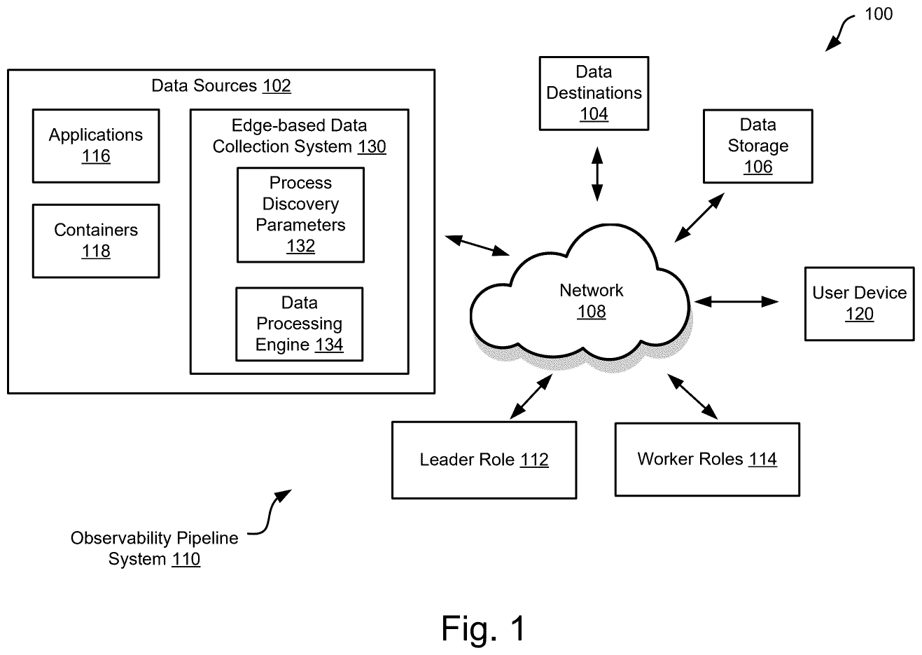

FIG. 1 is a block diagram showing aspects of an example computing environment 100. The example computing environment 100 includes data sources 102, data destinations 104, data storage 106, network 108, a user device 120, and an observability pipeline system 110. The observability pipeline system 110 includes a leader role 112, worker roles 114, and an edge-based data collection system that includes edge agents 130 running on the data sources 102. Each edge agent 130 can be deployed as an application or another type of software module running on the computer nodes that operate as data sources 102. The computing environment 100 may include additional or different features, and the elements of the computing environment 100 may be configured to operate as described with respect to FIG. 1 or in another manner.

In some implementations, the computing environment 100 contains the computing infrastructure of a business enterprise, an organization or another type of entity or group of entities. During operation, various data sources 102 in an organization's computing infrastructure produce volumes of machine data that contain valuable or useful information. The machine data may include data generated by the organization itself, data received from external entities, or a combination. By way of example, the machine data can include network packet data, sensor data, application program data, observability data, and other types of data. Observability data can include, for example, system logs, error logs, stack traces, system performance data, or any other data that provides information about computing infrastructure and applications (e.g., performance data and diagnostic information). The observability pipeline system 110 can receive and process the machine data generated by the data sources 102. For example, the machine data can be processed to diagnose performance problems, monitor user interactions, and to derive other insights about the computing environment 100. Generally, the machine data generated by the data sources 102 does not have a common format or structure, and the observability pipeline system 110 can generate structured output data having a specified form, format, or type. The output generated by the observability pipeline system can be delivered to data destinations 104, data storage 106, user devices 120, or a combination of these and other destinations. In some cases, the data delivered to the data storage 106 includes the original machine data that was generated by the data sources 102, and the observability pipeline system 110 can later retrieve and process the machine data that was stored on the data storage 106.

In general, the observability pipeline system 110 can provide a number of services for processing and structuring machine data for an enterprise or other organization. In some instances, the observability pipeline system 110 provides schema-agnostic processing, which can include, for example, enriching, aggregating, sampling, suppressing, or dropping fields from nested structures, raw logs, and other types of machine data. The observability pipeline system 110 may also function as a universal adapter for any type of machine data destination. For example, the observability pipeline system 110 may be configured to normalize, de-normalize, and adapt schemas for routing data to multiple destinations. The observability pipeline system 110 may also provide protocol support, allowing enterprises to work with existing data collectors, shippers, and agents, and providing simple protocols for new data collectors. In some cases, the observability pipeline system 110 can test and validate new configurations and reproduce how machine data was processed. The observability pipeline system 110 may also have responsive configurability, including rapid reconfiguration to selectively allow more verbosity with pushdown to data destinations or collectors. The observability pipeline system 110 may also provide reliable delivery (e.g., at least once delivery semantics) to ensure data integrity with optional disk spooling.

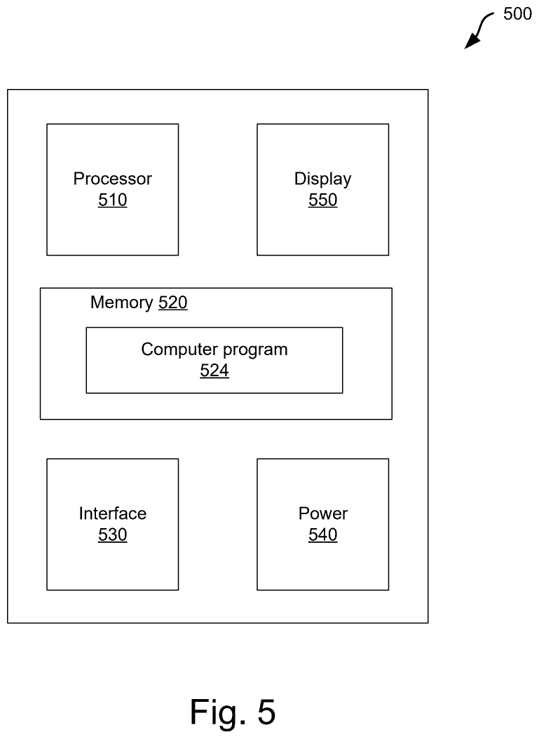

The data sources 102, data destinations 104, data storage 106, observability pipeline system 110, and the user device 120 are each implemented by one or more computer systems that have computational resources (e.g., hardware, software, and firmware) that are used to communicate with each other and to perform other operations. For example, each computer system may be implemented as the example computer system 500 shown in FIG. 5 or components thereof. In some implementations, computer systems in the computing environment 100 can be implemented in various types of devices, such as, for example, laptops, desktops, workstations, smartphones, tablets, sensors, routers, mobile devices, Internet of Things (IoT) devices, and other types of devices. Aspects of the computing environment 100 can be deployed on private computing resources (e.g., private enterprise servers, etc.), cloud-based computing resources, or a combination thereof. Moreover, the computing environment 100 may include or utilize other types of computing resources, such as, for example, edge computing, fog computing, etc.

The data sources 102, data destinations 104, data storage 106, observability pipeline system 110, and the user device 120 and possibly other computer systems or devices communicate with each other over the network 108. The example network 108 can include all or part of a data communication network or another type of communication link. For example, the network 108 can include one or more wired or wireless connections, one or more wired or wireless networks, or other communication channels. In some examples, the network 108 includes a Local Area Network (LAN), a Wide Area Network (WAN), a private network, an enterprise network, a Virtual Private Network (VPN), a public network (such as the Internet), a peer-to-peer network, a cellular network, a Wi-Fi network, a Personal Area Network (PAN) (e.g., a Bluetooth low energy (BTLE) network, a ZigBee network, etc.) or other short-range network involving machine-to-machine (M2M) communication, or another type of data communication network.

The data sources 102 can include multiple user devices, servers, sensors, routers, firewalls, switches, virtual machines, containers, or a combination of these and other types of computer devices or computing infrastructure components. Part of the observability pipeline system 110 on the data sources 102 enable the data sources 102 to detect, monitor, create, or otherwise produce machine data during their operation. In some instances, the machine data may be provided to the leader role 112 or the worker role 114 of the observability pipeline system 110 through the network 108 for further processing. In some cases, the machine data are formatted into pipeline input data to the data processing engine 134 of the edge agent 130

The data sources 102 can include data sources designated as push sources (e.g.,, Splunk HEC, Syslog, Elasticsearch API, TCP JSON, TCP Raw, HTTP/S, Raw HTTP/S, Kinesis Firehose, SNMP Trap, Metrics, and others), pull sources (e.g., Kafka, Kinesis Streams, SQS, S3, Google Cloud Pub/Sub, Azure Blob Storage, Azure Event Hubs, Office 365 Services, Office 365 Activity, Office 365 Message Trace, Prometheus, and others), and other types of data sources.

In some implementations, the data sources 102 includes applications 116. In the example shown in FIG. 1, an application 116 includes a collection of computer instructions that constitute a computer program. The computer instructions reside in memory and execute on a processor. The computer instructions can be compiled or interpreted. An application 116 can be contained in a single module or can be statically or dynamically linked with other libraries. The libraries can be provided by the operating system or the application provider. The application 116 can be written in a variety of computer languages, including Java, “C,”“C++,”Python, Pascal, Go, or Fortran as a few examples.

As shown in FIG. 1, the edge agent 130 includes process discovery parameters 132 and a data processing engine 134. In certain cases, the edge agent 130 may include other components. In some implementations, the process discovery parameters 132 specify values that are used to filter or select processes running on the one or more data sources. In some instances, the values of the process discovery parameters 132 can be pre-determined at default values by the edge agent 130, for example, when installed on the one or more data sources 102. In some instances, the values of the process discovery parameters 132 can be configured, changed, or updated by a user of the one or more data sources 102 or the leader role 112 of the observability pipeline system 110.

In some implementations, the edge agent 130 operating on a computer node inspects the computer node; identifies processes running on the computer node (e.g., instances of the applications 116 or other types of processes); filters and selects processes according to the process discovery parameters; explores and discovers activity the discovered processes perform; extracts and formats activity data from the subset of the discovered processes; pre-process the activity data by operation of the data processing engine 134; and routes the extracted data or the pre-processed data to a data destination (e.g., a cloud-based centralized node, a user device, a data storage, the leader role 112 or the worker roles 114 of the observability pipeline system 110). In some implementations, the discovered processes are added to a list of monitored processes that are monitored by the observability pipeline system. In some implementations, when one or more of the process discovery parameters 132 are modified based on user input, a different subset of the identified processes is selected according to the modified process discovery parameters 132 and the list of monitored processes is updated to include the different subset of the identified processes to be monitored by the observability pipeline system.

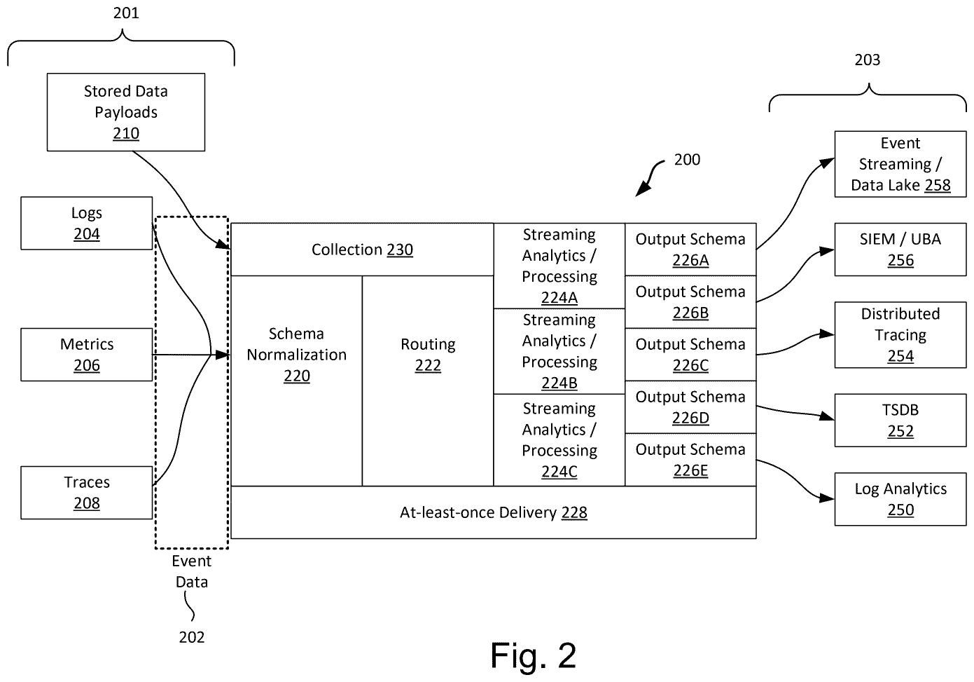

In some implementations, the activity data extracted from monitoring the discovered processes can be formatted to generate observability pipeline input data which can be processed by the data processing engine 134 to generate observability pipeline output data. The observability pipeline output data from the data processing engine 134 can be forwarded to other components (e.g., the leader role 112 or the worker roles 114) of the observability pipeline system 110 through the network 108 as shown in FIG. 1, where one or more sub-processes can be performed, or to data destinations 104 or data storage 106. In some instances, the edge-based data collection system 130 on a data source 102 can manage multiple other data sources 102. In some implementations, the observability pipeline output data from the data processing engine 134 can be augmented with metadata collected from the computer node. In certain examples, the augmented observability pipeline output data can be further transmitted to data destinations 104. In some implementations, the data processing engine 134 of the edge agent 130 has one or more of the features shown and described in the example data processing engine 200 in FIG. 2. In some examples, the data processing engine 134 of the data source 102 may be implemented in another manner.

The data destinations 104 can include multiple user devices, servers, databases, analytics systems, data storage systems, or a combination of these and other types of computer systems. The data destinations 104 can include, for example, log analytics platforms, time series databases (TSDBs), distributed tracing systems, security information and event management (SIEM) or user behavior analytics (UBA) systems, and event streaming systems or data lakes (e.g., a system or repository of data stored in its natural/raw format). The observability pipeline output data produced by the observability pipeline system 110 can be communicated to the data destinations 104 through the network 108.

The data storage 106 can include multiple user devices, servers, databases, or a combination of these and other types of data storage systems. Generally, the data storage 106 can operate as a data source or a data destination (or both) for the observability pipeline system 110. In some examples, the data storage 106 includes a local or remote filesystem location, a network file system (NFS), Amazon S3 buckets, S3-compatible stores, other cloud-based data storage systems, enterprise databases, systems that provides access to data through REST API calls or custom scripts, or a combination of these and other data storage systems. The observability pipeline output data, which may include the machine data from the data sources 102 as well as data analytics and other output from the observability pipeline system 110, can be communicated to the data storage 106 through the network 108.

The observability pipeline system 110 may be used to monitor, track, and triage events by processing the machine data from the data sources 102. The observability pipeline system 110 can receive an event data stream from each of the data sources 102 and identify the event data stream as observability pipeline input data to be processed by one or more of the data processing engines 134, the leader role 112 or the worker roles 114 of the observability pipeline system 110. The observability pipeline system 110 generates observability pipeline output data by applying observability pipeline processes to the observability pipeline input data and communicates the observability pipeline output data to the data destinations 104. In some implementations, the observability pipeline system 110 operates as a buffer between data sources 102 and data destinations 104, such that some data sources 102 can send their data to the observability pipeline system 110, which handles filtering and routing the data to proper data destinations.

In some implementations, the observability pipeline system 110 unifies data processing and collection across many types of machine data (e.g., metrics, log files, and traces). The machine data can be processed by the observability pipeline system 110 by enriching it and reducing or eliminating noise and waste, or otherwise formatting it. The observability pipeline system 110 may also deliver the processed data to any tool in an enterprise designed to work with observability data. For example, the observability pipeline system 110 may analyze event data and send analytics to multiple data destinations 104, thereby enabling the systematic observation of event data for known conditions which require attention or other action. Consequently, the observability pipeline system 110 can decouple data sources of machine data from data destinations and provide a buffer that makes many, diverse types of machine data easily consumable.

In some example implementations, the observability pipeline system 110 can operate on any type of machine data generated by the data sources 102 to properly observe, monitor, and secure the running of an enterprise's infrastructure and applications 116 while reducing or minimizing overlap, wasted resources, and cost. Specifically, instead of using different tools for processing different types of machine data, the observability pipeline system 110 can unify data collection and processing for all types of machine data (e.g., logs 204, metrics 206, and traces 208 shown in FIG. 2) and route the processed machine data to multiple data destinations 104. Unifying data collection can minimize or reduce redundant agents with duplicate instrumentation and duplicate collection for the multiple destinations. Unifying processing may allow routing of processed machine data to disparate data destinations 104 while adapting data shapes and controlling data volumes.

In an example, the observability pipeline system 110 obtains DogStatsd metrics, processes the DogStatsd metrics (e.g., by enriching the metrics), sends processed data having high cardinality to a first destination (e.g., Honeycomb) and processed data having low cardinality to a second, different destination (e.g., Datadog). In another example, the observability pipeline system 110 obtains windows event logs, sends full fidelity processed data to a first destination (e.g., an S3 bucket), and sends a subset (e.g., where irrelevant events are removed from the full fidelity processed data) to one or more second, different destinations (e.g., Elastic and Exabeam). In another example, machine data can be obtained from a Splunk forwarder and processed (e.g., sampled). The raw processed data may be sent to a first destination (e.g., Splunk). The raw processed data may further be parsed, and structured events may be sent to a second destination (e.g., Snowflake).

In some implementations, the leader role 112 of the observability pipeline system 110 leads the overall operation by configuring and monitoring the worker roles 114 of the observability system 110. The worker roles 114 of the observability pipeline system 110 may receive observability pipeline output data from the data processing engine 134 of the edge agent 130 on the data sources 102, and may apply further observability pipeline processes to the received data, and deliver pipeline output data to the data destinations 104 and data storage 106.

The observability pipeline system 110 may deploy the leader role 112 and a number of worker roles 114 on a single computer node or on many computer nodes. For example, the leader role 112 and one or more worker roles 114 may be deployed on the same computer node. Or in some cases, the leader role 112 and each of the worker roles 114 may be deployed on distinct computer nodes. The distinct computer nodes can be, for example, distinct computer devices, virtual machines, containers, processors, or other types of computer nodes.

The user device 120 or another computer node in the observability pipeline system 110 can provide a user interface for the observability pipeline system 110. Aspects of the user interface can be rendered on a display (e.g., the display 550 in FIG. 5) or otherwise presented to a user. The user interface may be generated by an observability pipeline application that interacts with the observability pipeline system 110. The observability pipeline application can be deployed as software that includes application programming interfaces (APIs), graphical user interfaces (GUIs), and other modules.

In some implementations, an observability pipeline application (e.g., the edge agent 130, or another type of application or software module) can be deployed as a file, executable code, or another type of machine-readable instructions executed on a computer node. The observability pipeline application, when executed, may render GUIs for display to a user (e.g., on a touchscreen, a monitor, or other graphical interface device), and the user can interact with the observability pipeline application through the GUIs. Certain functionality of the observability pipeline application may be performed on the data sources 102 or the user device 120 or may invoke the APIs, which can access functionality of the observability pipeline system 110. The observability pipeline application may be rendered and executed within another application (e.g., as a plugin in a web browser), as a standalone application, or otherwise. In some cases, an observability pipeline application may be deployed as an installed application on a workstation, as an “app” on a tablet or smartphone, as a cloud-based application that accesses functionality running on one or more remote servers, or otherwise.

In some implementations, multiple components or aspects of the observability pipeline system 110 are deployed on a single computer node, for example, on a data source 102 or another computer device in the computing environment 100. The computer node can operate as one or more of the edge agent 130, the leader role 112 and the worker roles 114 and may execute an observability pipeline application that provides a user interface as described above. In some cases, the edge agents 130, the leader role 112 and each of the worker roles 114 are deployed on distinct components (e.g., distinct processors, distinct cores, distinct virtual machines, etc.) within a single computer node. In such cases, they can communicate with each other by exchanging signals within the computer device, through a shared memory, or otherwise.

In some implementations, the observability pipeline system 110 is deployed on a distributed computer system that includes multiple computer nodes. For instance, the observability pipeline system 110 can be deployed on a server cluster, on a cloud-based “serverless” computer system, or another type of distributed computer system. The computer nodes in the distributed computer system may include a number of endpoint devices operating as data sources 102, a leader node operating as the leader role 112 and multiple worker nodes operating as the respective worker roles 114. One or more computer nodes of the distributed computer system (e.g., the leader node) may communicate with the user device 120, for example, through an observability pipeline application that provides a user interface as described above. In some cases, the data sources, the leader node and each of the worker nodes are distinct computer devices in the computing environment 100. In some cases, the data sources, the leader node and each of the worker nodes can communicate with each other using TCP/IP protocols or other types of network communication protocols transmitted over a network (e.g., the network 108 shown in FIG. 1) or another type of data connection.

In some implementations, the observability pipeline system 110 includes software installed on private enterprise servers, a private enterprise computer device, or other types of enterprise computing infrastructure (e.g., one or more computer systems owned and operated by corporate entities, government agencies, other types of enterprises). In such implementations, some or all of the data sources 102, data destinations 104, data storage 106, and the user device 120 can be or include the enterprise's own computer resources, and the network 108 can be or include a private data connection (e.g., an enterprise network or VPN). In some cases, the observability pipeline system 110 and the user device 120 (and potentially other elements of the computer environment 100) operate behind a common firewall or other network security system.

In some implementations, the observability pipeline system 110 includes software running on a cloud-based computing system that provides a cloud hosting service. For example, the observability pipeline system 110 may be deployed as a SaaS system running on the cloud-based computing system. For example, the cloud-based computing system may operate through Amazon® Web Service (AWS) Cloud, Microsoft Azure Cloud, Google Cloud, DNA Nexus, or another third-party cloud. In such implementations, some or all of the data sources 102, data destinations 104, data storage 106, and the user device 120 can interact with the cloud-based computing system through APIs, and the network 108 can be or include a public data connection (e.g., the Internet). In some cases, the observability pipeline system 110 and the user device 120 (and potentially other elements of the computer environment 100) operate behind different firewalls, and communication between them can be encrypted or otherwise secured by appropriate protocols (e.g., using public key infrastructure or otherwise).

In some implementations, the data sources 102 each include one or more containers 118, and an edge agent 130 running on a data source can identify files and monitor data in the containers 118 running on that data source. When the identified files include a file defined in a container 118, a modified path for the file can be identified by operation of the edge agent 130. In some implementations, the modified path allows a process (e.g., the edge agent 130) running outside the container to access the file in the container 118.

In some implementations, the edge agent 130 is operated in one of the containers 118 on the data source 102. In this case, when identifying processes running on the computer node, a root file system of the computer node can be mounted, and the edge agent 130 can identify processes running in other containers 118 of the computer node by scanning the root file system. In some implementations, a container discovery process is performed to identify containers running on the computer node. Processes in each of the containers are detected; and a list of the processes is added to the list of processes to be monitored by the observability pipeline system 110 if they match the process discovery filter criteria. In some implementations, processes in each of the containers are detected and data collected through one or more sockets.

In some instances, container metrics for one or more of the containers 118 are collected, and observability pipeline input data is generated by formatting the container metrics. The observability pipeline input data can then be processed by the data processing engine 134 of the edge agent 130. When the observability pipeline input data is processed, resource utilization on the computer node and a duration of processing can be measured and determined.

FIG. 2 is a block diagram showing aspects of an example data processing engine 200. The example data processing engine 200 may be implemented by one or more of the data sources 102, the leader role 112, the worker roles 114 or other components shown in FIG. 1, or the data processing engine 200 may be implemented in another type of system.

The example data processing engine 200 shown in FIG. 2 includes data collection 230, schema normalization 220, routing 222, streaming analytics and processing 224A, 224B, 224C, and output schematization 226A, 226B, 226C, 226D, 226E. The data processing engine 200 may include additional or different operations, and the operations of the data processing engine 200 may be performed as described with respect to FIG. 2 or in another manner. In some cases, one or more of the operations can be combined, or an operation can be divided into multiple sub-processes. Certain operations may be iterated or repeated, for example, until a terminating condition is reached. In some cases, one or more of the operations may receive observability pipeline input data 201 generated by an edge agent operating on an endpoint device or another data source.

As shown in FIG. 2, the data processing engine 200 is applied to observability pipeline input data 201 from data sources, and the data processing engine 200 delivers pipeline output data 203 to data destinations. The data sources can include any of the example data sources 102 or data storage 106 described with respect to FIG. 1, and the data destinations can include any of the example data destinations 104 or data storage 106 described with respect to FIG. 1.

The example observability pipeline input data 201 shown in FIG. 2 includes logs 204, metrics 206, traces 208, stored data payloads 210, and possibly other types of machine data. In some cases, some or all of the machine data can be generated by agents (e.g., Fluentd, Collectd, OpenTelemetry) that are deployed at the data sources, for example, on various types of computing devices in a computing environment (e.g., in the computing environment 100 shown in FIG. 1, or another type of computing environment). The logs 204, metrics 206, and traces 208 can be decomposed into event data 202 that are consumed by the data processing engine 200. In some instances, logs 204 can be converted to metrics 206, metrics 206 can be converted to logs 204, or other types of data conversion may be applied. In some cases, the logs 204, metrics 206, traces 208, and stored data payloads 210 that constitute the example observability pipeline input data 201, may be provided by an edge agent 130 as shown in FIG. 1 or another type of agent.

In the example shown, the stored data payloads 210 represent event data retrieved from external data storage systems. For instance, the stored data payloads 210 can include event data that an observability pipeline process previously provided as output to the external data storage system.

The event data 202 are streamed to the data processing engine 200 for processing. Here, streaming refers to a continual flow of data, which is distinct from batching or batch processing. With streaming, data are processed as they flow through the system continuously (as opposed to batching, where individual batches are collected and processed as discrete units). As shown in FIG. 2, the event data from the logs 204, metrics 206, and traces 208 are streamed directly to the schema normalization process (at 220) without use of the collection process (at 230), whereas the event data from the stored data payloads 210 are streamed to the collection process (at 230) and then streamed to the schema normalization process (at 220), the routing process (at 222) or the streaming analytics and processing (at 224).

In some instances, event data 202 represents events as structured or typed key value pairs that describe something that occurred at a given point in time. For example, the event data 202 can contain information in a data format that stores key-value pairs for an arbitrary number of fields or dimensions, e.g., in JSON format or another format. A structured event can have a timestamp and a “name” field. Instrumentation libraries can automatically add other relevant data like the request endpoint, the user-agent, or the database query. In some implementations, components of the events data 202 are provided in the smallest unit of observability (e.g., for a given event type or computing environment). For instance, the event data 202 can include data elements that provide insight into the performance of the computing environment 100 to monitor, track, and triage incidents (e.g., to diagnose issues, reduce downtime, or achieve other system objectives in a computing environment).

In some instances, logs 204 represent events serialized to disk, possibly in several different formats. For example, logs 204 can be strings of text having an associated timestamp and written to a file (often referred to as a flat log file). The logs 204 can include unstructured logs or structured logs (e.g., in JSON format). For instance, log analysis platforms store logs as time series events, and the logs 204 can be decomposed into a stream of event data 202.

In some instances, metrics 206 represent summary information about events, e.g., timers or counters. For example, a metric can have a metric name, a metric value, and a low cardinality set of dimensions. In some implementations, metrics 206 can be aggregated sets of events grouped or collected at regular intervals and stored for low cost and fast retrieval. The metrics 206 are not necessarily discrete and instead represent aggregates of data over a given time span. Types of metric aggregation are diverse (e.g., average, total, minimum, maximum, sum-of-squares) but metrics typically have a timestamp (representing a timespan, not a specific time); a name; one or more numeric values representing some specific aggregated value; and a count of how many events are represented in the aggregate.

In some instances, traces 208 represent a series of events with a parent/child relationship. A trace may provide information of an entire user interaction and may be displayed in a Gantt-chart like view. For instance, a trace can be a visualization of events in a computing environment, showing the calling relationship between parent and child events, as well as timing data for each event. In some implementations, individual events that form a trace are called spans. Each span stores a start time, duration, and an identification of a parent event (e.g., indicated in a parent-id field). Spans without an identification of a parent event are rendered as root spans.

The example observability pipeline output data 203 shown in FIG. 2 include data formatted for log analytics platforms (250), data formatted for time series databases (TSDBs) (252), data formatted for distributed tracing systems (254), data formatted for security information and event management (SIEM) or user behavior analytics (UBA) systems 256, and data formatted for event streaming systems or data lakes 258 (e.g., a system or repository of data stored in its natural/raw format). Log analytics platforms are configured to operate on logs to generate statistics (e.g., web, streaming, and mail server statistics) graphically. TSDBs operate on metrics; example TSDBs include Round Robin Database (RRD), Graphite's Whisper, and OpenTSDB. Tracing systems operate on traces to monitor complex interactions, e.g., interactions in a microservice architecture. SIEMs provide real-time analysis of security alerts generated by applications and network hardware. UBA systems detect insider threats, targeted attacks, and financial fraud. Observability pipeline output data 203 may be formatted for, and delivered to, other types of data destinations in some cases.

In the example shown in FIG. 2, the data processing engine 200 includes a schema normalization module that (at 220) converts the various types of event data 202 to a common schema or representation to execute shared logic across different agents and data types. For example, machine data from various agents such as Splunk, Elastic, Influx, and OpenTelemetry have different, opinionated schemas, and the schema normalization module can convert the event data to normalized event data. Machine data intended for different destinations may need to be processed differently. Accordingly, the data processing engine 200 includes a routing module that (at 222) routes the normalized event data (e.g., from the schema normalization module 220) to different processing paths depending on the type or content of the event data. The routing module can be implemented by having different streams or topics. The routing module routes the normalized data to respective streaming analytics and processing modules. FIG. 2 shows three streaming analytics and processing modules, each applied to normalized data (at 224A, 224B, 224C); however, any number of streaming analytics and processing modules may be applied. Each of the streaming analytics and processing modules can aggregate, suppress, mask, drop, or reshape the normalized data provided to it by the routing module. The streaming analytics and processing modules can generate structured data from the normalized data provided to it by the routing module. The data processing engine 200 includes output schema conversion modules that (at 226A, 226B, 226C, 226D, 226E) schematize the structured data provided by the streaming analytics and processing modules. The structured data may be schematized for one or more of the respective data destinations to produce the observability pipeline output data 203. For instance, the output schema conversion modules may convert the structured data to a schema or representation that is compatible with a data destination. In some implementations, the data processing engine 200 includes an at-least-once delivery module that (at 228) applies delivery semantics that guarantee that a particular message can be delivered one or more times and will not be lost. In some implementations, the data processing engine 200 includes an alerting or centralized state module, a management module, or other types of sub-processes.

In the example shown in FIG. 2, the data processing engine 200 includes a collection module that (at 230) collects filtered event data from stored data payloads 210. For example, the stored data payloads 210 may represent event data that were previously processed and stored on the event streaming/data lake 258 or event data that were otherwise stored in an external data storage system. For example, some organizations have a high volume of data that is kept in storage systems (e.g., S3, Azure Blob Store, etc.) for warehousing purposes, or they may have event data that can be scraped from a REST endpoint (e.g., Prometheus). The collection module may allow organizations to apply the data processing engine 200 to data from storage, REST endpoints, and other systems regardless of whether the data has been processed by an observability pipeline system in the past. The data collection module can retrieve the data from the stored data payload 210 on the external data storage system, stream the data to the data processing engine 200 (e.g., via the schema normalization module, the routing module, or a streaming analytics and processing module), and send the output to any of the data destinations 230.

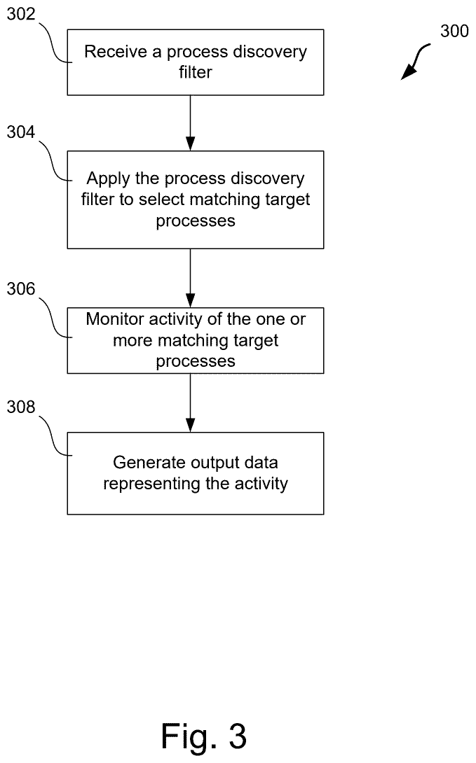

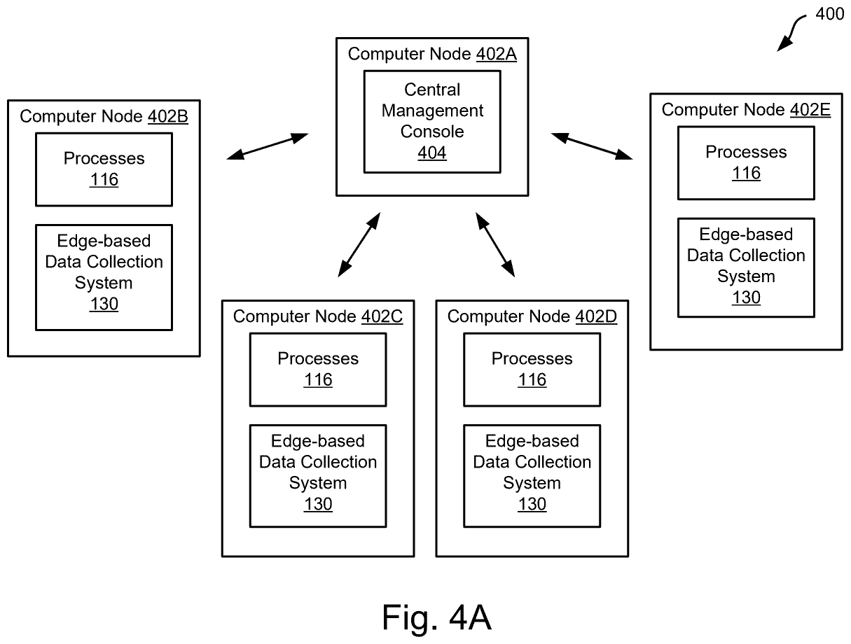

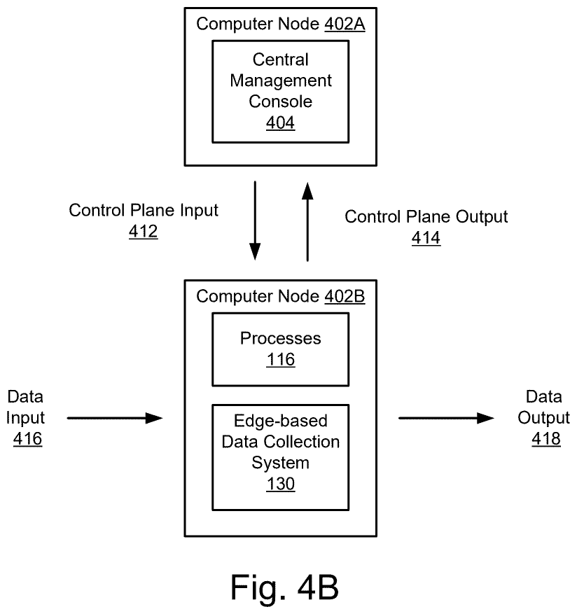

FIG. 3 is a flow chart showing aspects of an example process 300. In some implementations, the operations of the example process 300 are performed by an edge agent (e.g., the edge-based data collection system 130 shown in FIG. 1) on an endpoint device or another type of computer node (e.g., the data source 102 shown in FIG. 1 or the computer node 402B shown in FIG. 4A), and the edge agent operates as part of an observability pipeline system (e.g., as described with respect to FIG. 1 or in another manner). The example process 300 may include additional or different operations, including operations performed by additional or different components, and the operations may be performed in the order shown or in another order.

In some implementations, the edge agent is configured to collect host metrics (e.g., CPU, memory, disk, network, etc.) of the computer node. In some implementations, the edge agent is configured to discover if the computer node is running docker or is a k8s (Kubernetes) node and collect container metrics. In some implementations, the edge agent is configured to discover running processes (e.g., containerized or not containerized) and their corresponding activity. In some implementations, the edge agent is configured to provide other functionalities and perform other tasks. In some instances, the edge agent can be installed and configured on the computer node prior to being initiated for performing the operations in the example process 300.

In some implementations, the edge agent provides a user interface that allows the users to explore the discovered metrics (e.g., host, docker, k8s, etc.) of the computer node; to view, explore and search the discovered target processes and activity data; and to configure the edge agent. For example, through the user interface of the computer node, users can change collection level for some or all metrics; route some or all of extracted data to a data destination (e.g., through packs/pipelines); use interposed functions to attach to running processes for deeper introspection; or configure other aspects of the edge agent.

At 302, a process discovery filter is received. For example, an edge agent running on the computer node can receive the process discovery filter from a leader role operating on another computer node. In some implementations, the process discovery filter includes a set of criteria that describe characteristics, statistics, parameters, features, operations, or conditions corresponding to processes that may be running (e.g., executing) at the computer node. The process discovery filter and its corresponding set of criteria (e.g., process discovery parameters 132) can be defined in a manner that can be used to identify target processes of interest that are running on the computer node. For example, the criteria can be configured to identify processes that may be using excessive resources of the computer node, may be operating in an unexpected or erroneous manner, or may be operating in a manner that creates a potential vulnerability (e.g., security or privacy threat).

In some implementations, a data model representing an identified process can include attribute such as: process and parent process IDs; owner user and group IDs; program name, command-line arguments, and environment variables; start time and run time; CPU, memory, and file-descriptor utilization; and service, control group, and container contexts. In some implementations, the data model includes one or more other attributes.

Using a process discovery filter, for example, a user of the central management console can formulate custom filters based on the above attributes or choose from a curated list of preexisting filters. A filter can be created to identify legitimate or expected activity, such as by using criteria configured to identify: processes running a specified program with a given command-line argument; processes running as a given user or group; processes running in a Systemd or Windows service; or processes using given network ports. In some implementations, criteria are configured to identify other behavior or features defining a process of interest. A filter can be created to identify anomalous or illegitimate activity, such as by using criteria configured to identify: processes using excessive CPU, memory, IO, or file-descriptor resources; processes that crash; processes that are running programs outside of the standard package installation paths; processes running with elevated privilege; processes with open listening sockets on suspicious ports; processes running an executable binary that matches a given regexp; or processes with a higher than expected number of open files or sockets.

In some implementations, the process discovery filter is received from a central management console of a remote computer node (e.g., the other computer node mentioned above). For example, the central management console can be an application executing on the remote computer node that centrally manages the configuration or operation of edge-based data collection systems and/or provide an interface for controlling such configuration or operation. In some implementations, a user may specify a process discovery filter at an interface of the central management console. In some implementations, the central management console pushes (or causes to be pushed) the process discovery filter to one or more computer nodes that include edge-based data collection. An example central management console 404 is shown in FIGS. 4A and 4B and described below.

As noted above, processes running on the computer node can be identified (e.g., before and/or as part of filtering). For example, processes running on the computer node can be identified by directly scanning a list of running processes on the computer node, for example by accessing the operating system of the computer node using/proc/*. In some implementations, the edge agent identifies running processes on the computer node based on certain criteria, e.g., resource utilization, process duration, or another factor. For example, running processes that utilize at least X% CPU, at least Y% memory may be identified. For another example, processes that run for at least Z seconds may be identified. This heuristic process can be used to identify “relevant” applications.

In some implementations, identifying the processes running on the computer node includes identifying processes that are running in one or more containers on the computer node. In some implementations, a docker discovery process is used to obtain container metrics. In some instances, a docker discovery process can be used to report an inventory of containers on the computer node. In some instances, an API socket can be located for a docker server. Locations for the operating system (e.g., Linux distros, MacOS, windows, etc.) of the computer node can be searched. In response to a process running in a container where a file system of the computer node has been mounted, the same locations in the mounted volume can be searched. In some implementations, once the API socket is located, an event reporting details for the docker server, e.g., version, uptime, number of containers running and stopped, number of images, labels, numbers of volumes mounted, numbers of networks connected, resource usage, and other container metrics can be created.

In some instances, a process can be running in a container of the computer node isolated from the operating system of the computer node. A process ID lists control groups that the running process uses, and a container ID can be extracted from the control groups. For example, a Linux process ID (PID), /proc/{PID}/cgroup lists the control groups (e.g., “namespaces”) that a process uses. On a computer node with cgroup v1 enabled, example entries for a process that is running on the computer node and not running in a container are given as
12:memory:/user.slice/user-1000.slice/session-1530.scope
11:pids:/user.slice/user-1000.slice/session-1530.scope 10:hugetlb:/
9:blkio:/user.slice
8:cpuset:/
7:freezer:/
6:devices:/user.slice
5:cpu,cpuacct:/user.slice
4:net_cls,net_prio:/
3:rdma:/
2:perf_event:/
1:name=systemd:/user.slice/user-1000.slice/session-1530.scope
0::/user.slice/user-1000.slice/session-1530.scope
   Example entries for a process that is running in a container of a computer node are given as
12:memory:/docker/31aa1bcbffaf974e10526453fb7b645241557f29c3262157cf 670b9332762438
11:pids:/docker/31aa1bcbffaf974e10526453fb7645241557f29c3262157cf670b 9332762438
10:hugetlb:/docker/31aa1bcbffaf974e10526453fb7b645241557f29c3262157cf6 70b9332762438
9:blkio:/docker/31aa1bcbffaf974e10526453fb7b645241557f29c3262157cf670b 9332762438
8:cpuset:/docker/31aa1bcbffaf974e10526453fb7b645241557f29c3262157cf670 b9332762438
7:freezer:/docker/31aa1bcbffaf974e10526453fb7b645241557f29c3262157cf67 0b9332762438
6:devices:/docker/31aa1bcbffaf974e10526453fb7b645241557f29c3262157cf67 0b9332762438
5:cpu,cpuacct:/docker/31aa1bcbffaf974e10526453fb7b645241557f29c3262157 cf670b9332762438
4:net_cls,net_prio:/docker/31aa1bcbffaf974e10526453fb7b645241557f29c3262 157cf670b9332762438
3:rdma:/
2:perf_event:/docker/31aa1bcbffaf974e10526453fb7b645241557f29c3262157cf 670b9332762438
1:name=systemd:/docker/31aa1bcbffaf974e10526453fb7b645241557f29c3262 157cf670b9332762438
0::/system.slice/containerd.service
   In this case, the container ID of 31aa1bcbffaf974e10526453fb7b645241557f29c3262157cf670b9332762438 can be extracted from the example entries for the process.
   For another example, on a computer node with cgroup v2 enabled, example entries for a process that is running on the computer node and not in a container are given as:
0::/user.slice/user-1000.slice/user@1000.service/app.slice/snap.code.code.63e42 2e0-8525-4103-8946-f8c84e89d2b8.scope
   Example entries for a process that is running in a container are given as:
0::/system.slice/docker-d139ba47385b92595718f325669fb88a0a3e0feabe770dbb778264f 402727524.scope
   In some instances, an expression, e.g.,/docker[-\\]([a-fA-F0-9]+)/can be used to check for and extract the docker container ID from the process'cgroupfile.

In some implementations, the edge agent includes metadata collector agents that are used to discover metadata and report specific defaults and configurations on the computer node. The metadata can be automatically added to events from any source that records various aspects of the computer node it's running. In some implementations, metadata includes details about the edge agent (e.g., version, configuration, etc.), details about the operating system of the computer node (e.g., name, version, hostname, user and group IDs, CPU, and memory resources, network interfaces, etc.), and names and values of all the environment variables. In some instances, when the AWS collector is connected to an application programing interface (API) that is available in EC2 instances, the metadata includes AWS region, instance type, labels, VPC, etc. for the VM. In some instances, the metadata may include other information about the computer node. The metadata may be processed by the observability pipeline system or may be augmented by observability pipeline output data. In some examples, the metadata processed or augmented can then be sent to a data destination (e.g., a data storage, or a user device).

In some cases, the edge agent, when installed on the computer node, includes stock configurations that can provide users with immediate visibility into the computer node by providing information such as: resource usage metrics (e.g., system wide or by process), container events and metrics (e.g., docker/k8s events and metrics), corresponding log files of the running processes, or other information. In some implementations, the above information is available to the user without performing additional configuration to the edge agent after it is installed on the computer node.

At 304, the process discovery filter is applied to select matching target processes. In some implementations, the process discovery filter is applied to a list of identified processes running on the computer node, and the subset of the identified processes that match a set of criteria of the filter are considered matching target processes.

In some implementations, the process discovery filter includes one or more parameters that are configured to define a set of criteria that can be applied to filter the identified processes. In some instances, process discovery parameters are specified at default values when the edge agent is installed on the computer node. The process discovery parameters and their values may be changed or updated, for example, by a user of the computer node through the user interface where the edge agent is operated on or the leader role of the observability pipeline system. In some instances, a user can provide input or feedback through the user interface to the edge agent of the computer node in response to a list of discovered processes presented to the user. For example, a user can remove one or more existing process discovery parameters, add one or more new process discovery parameters, update, edit or otherwise specify values for the process discovery parameters, or another type of action. In some instances, the process discovery parameters of the observability pipeline system may be stored locally on the computer node or remotely on the leader role of the observability pipeline system which can be accessed by the computer node through the network (e.g., the network 108 in FIG. 1).

In some implementations, the set of criteria of the process discovery filter identifies processes based on usage growth rate of a resource. For example, the criteria can define a characteristic that reflects the growth of resource usage by a process, such as a value reflecting change in usage over a time period (e.g., a difference between a current and previous usage, a slope of a curve that plots usage trend, or a determination that the current usage rate exceeds an expected usage rate based on historical or other data for the process). In some implementations, the resource usage includes one or more: central processing unit (CPU) usage, memory usage, or file-descriptor usage. In some implementations, usage measures time of usage, number of requests, and/or an amount of the resource used (e.g., amount of memory storage)

In some implementations, the set of criteria of the process discovery filter identifies processes based on running binaries that have crashed recently. In some implementations, the set of criteria of the process discovery filter identifies processes based on attributes of a binary being run that is associated with the processes. For example, attributes can include one or more of: path, stats, owner, or content regexp (also referred to as “regexp” or “regex”). In some implementations, the set of criteria of the process discovery filter identifies processes based on one or more running programs that are outside of standard package installation paths and that are associated with the processes. In some implementations, the set of criteria of the process discovery filter identifies processes based on the processes (or associated applications) running with elevated privilege. In some implementations, the one or more criteria of the filter identifies processes based on the processes being associated with sockets listening on suspicious ports. In some implementations, the set of criteria of the process discovery filter identifies processes based on the processes being associated with a higher than expected number of open files or sockets.

At 306, activity of the one or more matching target processes is monitored. For example, after processes of interest are identified that match the filter criteria, the activity of those processes can be monitored and collected as activity data for processing by the edge agent or another agent on the computer node, or by another computer node such as the leader node.

In some implementations, the activity of a process is monitored using one or more sources of activity data (also referred to here as monitoring sources). The ability to use multiple techniques to collect activity data can increase the effectiveness of edge agents in monitoring process activity. In some implementations, a monitoring source is monitoring of system calls made by a respective process. For example, system calls can be monitored using an operating system kernel utility such as “strace”, “systrace”, or other utility that logs or makes available system call activity of processes or applications. For instance, the strace utility attaches to a process and outputs a log when it detects the process make a system call to the kernel. Other utilities or techniques can be used to detect system call activity of processes (e.g., such as a debugger, eBPF, and/or function interposition).

In some implementations, data collected from the monitoring sources can be reported (e.g., output) as-is (e.g., without additional processing). In some embodiments, data collected from the monitoring sources can be processed and/or analyzed to identify trends (e.g., CPU/IO saturation durations, memory leakage, or file-descriptor leakage) or generate other second order data based on the collected data. In some implementations, this second order data is reported as collected activity data.

In some implementations, a monitoring source is monitoring via a system information kernel interface. For example, certain data can be exposed by an operating system kernel information interface such as “/proc”, “/sys”, or other interface that logs or makes available information about running processes or applications. For example, /proc/PID and/sys/PID are virtual file system directories available in Linux systems that can be used to view information about hardware and running processes with a given process ID (PID). Examples of data exposed via such interfaces include resource utilization and other state data including current CPU usage, current memory usage, and current file descriptor usage. Using such data, a process can be monitored to determine whether usage exceeds thresholds or changes unexpectedly, or see what files and network connections the process has open.

In some implementations, a monitoring source is monitoring using eBPF (which stands for “extended Berkeley Packet Filter”). For example, eBPF allows an application to run in kernel space, providing it the ability to access system-level activities at the kernel level without sacrificing the security and stability of the kernel. Therefore, eBPF programs can be used to extend the capabilities of an operating system without having to modify the operating system kernel. In some implementations, using eBPF to monitor activity includes using one or more eBPF applications to monitor kernel-level operations or information related to target matching processes. For example, kernel-level operations or information can include system calls, network events, or other activity. In some implementations, using eBPF enables the edge agent to intercept log writes avoiding the need to tail files on the file system and/or deal with log rotation. In some implementations, using eBPF enables the edge agent to report per-file-descriptor (i.e. per-socket or per-file) I/O metrics. In some implementations, monitoring using eBPF includes subscribing to events that are of interest and filtering by process.

In some implementations, a monitoring source is monitoring using function interposition. Function interposition is a concept of replacing calls to functions with calls to user-defined wrappers. In some implementations, function interposition is used to intercept system calls or other library calls. Several approaches to function interposition can be used in various cases. Examples include library preloading, function hooking, and Global Offsets Table (GOT) hooking.

Interposing a function call can be implemented such that an application is unaware, or at least does not need to be aware, of the interposition. Within an application, a call to a named function can ultimately result in a call to a particular address in computer memory. In an example, the executable code at the specified location is executed, and the function returns to the caller. With interposition, the application transfers control to a second (interposed) function, the interposed function executes, e.g., extracts performance information, and can then call the original function. The original function executes, then returns control back to the calling application. In some cases, the original function returns an output to the application. In an example, the original caller continues to execute as if the interposition never happened.

Function interposition, executing in user mode (in contrast to kernel mode), can extract detailed information from applications in production environments as inputs to an observability pipeline.

An application, or executable, can include modules that are specific to the application, modules from other applications, and modules from the underlying operating system. Executables may also be referred to as programs. Code from modules external to an executable can be grouped and presented as a library. Libraries can then be “linked” to the executable. Libraries can be static or dynamic. Static libraries, while usable by multiple executables, are locked into a program at compile time. On the other hand, dynamic (or shared) libraries exist as separate objects outside of the executable file. Typically, a static library's code cannot be modified without recompiling. In contrast, a dynamic library can be modified without having to recompile any dependent programs. Furthermore, in the case of a dynamic library, multiple running applications can use a shared copy of the library rather than each application having its own copy. An application can make calls to functions within the library or within its own executable. In various examples, any of these function calls can be interposed. In some cases, a library can be created or configured through a command line user interface.

Another type of function interposition is Global Offset Table (GOT) Hooking. GOT Hooking can be used when an application loads libraries itself, independently of the dynamic loader. For example, the Python interpreter loads libraries in support of import statements. Additionally, Apache loads libraries as a part of module management, as defined in configuration files. GOT hooking can be used to interpose functions deployed in any of these application-loaded libraries.

In some examples, a dynamic linker uses a Procedure Linkage Table (PLT) to enable calling of external functions. In some cases, the complete address resolution is accomplished by the dynamic linker when an executable is loaded. The GOT can be used to resolve addresses in conjunction with the PLT. The PLT typically includes the code that gets executed when an external function is called, while the GOT typically includes data that defines the actual function address.

Applications may call functions that are embodied in objects, e.g., shared libraries, that are external to the application itself. An operating system can provide many shared libraries. An objective can be to relieve an application from a need to duplicate common functionality.

The PLT represents code to be executed when an external function is called by an application. Code in the PLT references a specific entry in the GOT. The GOT entry, in turn, represents the memory address of the function to be called by the application. Together the PLT and GOT create the capability for dynamic linking of functions with an application.

In some examples, a dynamic loader can use what is known as lazy binding. By convention, when a dynamic linker loads a library, it will put an identifier and a resolution function into known places, or addresses, in the GOT. In some cases, a first call to an external function uses a call to a default stub in the PLT. The PLT loads the identifier and calls into the dynamic linker. The linker resolves the address of the function being called, and the associated GOT entry is updated. The next time the PLT entry is called, it will load the actual address of the function from the GOT, rather than the dynamic loader lookup. To interpose a function using GOT Hooking, an entry in the GOT is replaced with the address of the function that will perform the interposition.

In some cases, the original function may be part of a statically linked executable. In other cases, the original function may be part of the application or a module of the application source code. Function hooking is another type of interposition and can be used to implement function interposition in statically linked executables, such as Go applications. It can be accomplished by modifying code that implements the function to be interposed. In some cases, function hooking places a “JMP” (jump) assembly language instruction in the function to be interposed. The “JMP” causes a redirection to the address of the interposed function. The actual modification depends on the hardware architecture and instruction definition.

In some implementations, monitored activity can include system calls made by the process, communication or traffic destined for the process, communication or traffic originating from the process, files (e.g., log files) written to and/or read by the process, and/or resources used by the process.

In some implementations, the edge agent receives monitoring instructions from a leader role. For example, the leader role can provide the process discovery filter as well as instructions describing what activities the edge agent should monitor and/or which monitoring sources to use to monitor activities of matching target processes. In some implementations, the monitoring instructions are received with (e.g., as part of or together with) the process discovery filter. In some implementations, the monitoring instructions are received separately from the process discovery filter. In some implementations, the monitoring instructions are default monitoring instructions received from a leader role. For example, the monitoring instructions can be configured by a user and distributed by the leader role to identify a particular set of activities that are of interest to the user. These monitoring instructions are then used when monitoring process activity (e.g., according to a particular process discovery filter associated with the monitoring instructions or any process discovery filter if the monitoring instructions are generally applicable default instructions). when investigating processes running on computer nodes in the observability pipeline system. For another example, the user can specify via the leader node monitoring instructions (e.g., preferences) to use particular sources of activity data (e.g., a particular eBPF application), to collect particular data using those or any monitoring sources, to process activity data in a particular way, to format activity data (or associated output) in a particular format, and/or to store activity data (or associated output) in a particular location.

In some implementations, the edge agent determines what activities it will monitor and/or which monitoring sources to use to monitor activities of matching target processes. For example, the edge agent can be configured to use a heuristic or a default configuration to determine what and/or how to monitor with respect to activity of interest.

In some implementations, the edge agent runs directly on the computer node. In this case, a process running in a container isolated from the operating system of the computer node writes to a file. This path of the file can be resolved by processes running inside the same container. In some instances, the container ID of container where the process is running can be identified; and the container ID can then be used to obtain the container details, for example, from the Docker API. The container details include the path on the file system of the computer node where the containers internal file system is built. In some implementations, the container path is then used to prefix the file path to obtain the actual path. For example, when a file path is/tmp/foo.log, and the container path is /var/lib/docker/overlay2/e0b . . . 542a/merged, the actual path of the file is determined as /var/lib/docker/overlay2/e0b . . . 542a/merged/tmp/foo.log.

In some implementations, the edge agent and the process are running on separate, distinct containers in the same computer node. For example, the edge agent may run in a first container while a process is running in a second, distinct container, and the actual path of the corresponding file where the process writes to is /hostfs/var/lib/docker/overlay2/e0b . . . 542a/merged/tmp/foo.log.

In some implementations, the list of discovered processes is added to the list of monitored processes. The list of monitored processes includes processes that are monitored by the observability pipeline system. In some instances, the list of monitored processes may be stored locally on the same computer node, for example in a memory device of the compute node (e.g., the memory 520 in FIG. 5) which can be accessed by the data processing engine of the edge agent of the computer node. In some instances, the list of monitored processes may be stored remotely on other locations. For example, the list of monitored processes may be stored remotely on the leader role of the observability pipeline system and the list of discovered processes can be transferred through the network and added to the list of monitored processes. In some implementations, the data processing engine 134 of the edge agent 130 can monitor processes according to the list of discovered processes. In some implementations, data is extracted from the list of discovered processes and the extracted data is formatted and used to generate observability pipeline input data for the data processing engine. The observability pipeline input data is then processed by operation of the data processing engine on the computer node to generate observability pipeline output data.

At 308, output data representing the monitored activity is output. In some implementations, the edge agent processes collected activity data and stores the data in a location on the observability pipeline system. In some cases, the location is on the computer node of the edge agent. For example, the edge agent can store the output data locally and provide it to a leader node at a later time (e.g., in response to a request or in a next status update to the leader node). In some cases, the location is on a different computer node than the edge agent. In some cases, the location is a dedicated data storage repository (e.g., a data warehouse or a data lake). In some implementations, the output data is used to generate visual output that can be displayed (e.g., at the computer node of the edge agent or the central management console) to provide a user the ability to view the data.

In some implementations, the output data includes a report of events and/or metrics derived from or included in the collected activity data. In some implementations, the events and/or metrics include resource utilization events or metrics (e.g., CPU time, memory usage, 10 rates, FD counts, uptime). In some implementations, the events and/or metrics include file system activity events or metrics (e.g., paths opened/closed, created/removed, read/written). In some implementations, the events and/or metrics include network activity events or metrics (e.g., sockets opened/closed, read/written). In some implementations, the events and/or metrics include application activity events or metrics (e.g., DNS/HTTP requests/responses). In some implementations, the events and/or metrics include metadata events or metrics (e.g., matching process counts, discovery overhead resources).

In some implementations, the operations of the example process 300 are executed by operation of a process unit of the computer node during the log data collection. In certain implementations, when the computer node includes multiple processor units or multiple cores with multiple applications running in parallel, data that is generated from such data source (e.g., a k8s node) could be enormous for a single worker process to handle. In this case, the edge agent can be scaled. For example, the activity data collection agent of the edge agent can be divided into two or more worker processes. One worker process can be configured for discovering processes, during the discover stage. After the discover stage, discovered processes can be distributed to other worker processes during which the activity data collection stage is performed. In some implementations, dividing the activity data collection agent into multiple worker processes for different operations is performed and coordinated by operation of RPC (remote procedure calls), API (application programming interfaces) servers, or other components/units.

In some implementations, the edge agent is configured to collect o11y (observability) data or other types of data. In some implementations, the edge agent is configured according to user's instructions specified by data collection parameters. The edge agent can collect values of data collection parameters from the users. For example, users may specify values of the data collection parameters, such as level of time granularity (e.g., 1 minute, 10 seconds, 1 second, or another time interval), level of dimensional granularity, whether it needs utilization by vCPU, net rx/tx by interface, or other data collection parameters.

In some implementations, one or more data collection parameters may be grouped together into multiple distinct levels. For instance, users may have the opportunity to select “o11y level”. In some instances, o11y level may include three levels.

For example, level 0 provides metrics aggregated at the system level (e.g., no per core, or process etc.); level 1 breaks down metrics by properties of the system (e.g., vCPU, network interface, mountpoint, etc.); and level 2 breaks down metrics by process. Parameters may be handled in another manner in some cases.

FIG. 4A is a schematic diagram showing aspects of example computer nodes of an observability pipeline system 400. Example observability pipeline system 400 in FIG. 4A can be, or operate as discussed with respect to, observability pipeline system 110 of FIG. 1. Observability pipeline system 400 includes several computer nodes 402A-402E. Computer node 402A includes central management console 404. Central management console 404 represents a set of processes, applications, and/or functionality that, automatically (e.g., based on a default or user-defined configuration) or as instructed by a user, centrally manages or instructs operation of the observability pipeline system. For example, central management console 404 can operate as a leader role (e.g., as a leader node) for central management console 404 that sends process discovery filters and other instructions to computer nodes 402B-402E. In this regard, a user of central management console 404 can specify characteristics of processes (e.g., filter criteria) and/or activity of interest that they would like the edge agent of observability pipeline system 400 to monitor and report on. Instructions to perform process discovery and monitoring can then be pushed to some or all of the computer nodes of the system in order to effectively and easily discover processes running on system nodes. For instance, an issue discovered on one node can be translated into filter criteria and then investigated on all nodes. This can increase the effectiveness of the observability pipeline system and its ability to surface relevant data.

Computer nodes 402B-402E in FIG. 4A are computer nodes operating in a worker role. Each one of computer nodes 402B-402E includes a respective set of processes 116 running on the node. Each one of computer nodes 402B-402E also includes a respective edge-based data collection system 130, also referred to as an edge agent. The edge agent of each node can receive process discovery filters from central management console 404, apply the filters to the respective processes 116 running on the same node, and monitor activity of matching processes as described throughout this disclosure.

FIG. 4B is a schematic diagram showing aspects of communication involving example computer nodes of an observability pipeline system. FIG. 4B illustrates computer node 402A and computer node 402B, as described with respect to FIG. 4A. FIG. 4B illustrates two types of communication, communication in the control plane and communication in the data plane. For example, and as described above, central management console 404 on computer node 402A can operate as a leader role that manages the operation and behavior of the edge agent (e.g., edge-based data collection system 130) of computer node 402B. Thus, computer node 402A and 402B exchange data in the “control plane”, which conceptually refers to data exchanged for the purpose of controlling or managing operation of the edge agent. In FIG. 4B, computer node 402A provides control plane input 412 (e.g., input to the edge agent), which can include data or instructions that include process discovery filters and/or monitoring instructions. In FIG. 4B, computer node 402B provides control plane output 414 (e.g., output from the edge agent), which can include data such as confirmation of instructions or operations, status information, or results data. In FIG. 4B, computer node 402B also exchanges data in the “data plane”, which conceptually refers to the flow of processed and/or unprocessed observability data and its source data. In this regard, computer node 402B receives (e.g., and processes) data input 416 and provides data output 418 in the data plane. For example, data input 416 can represent data used by the edge agent to perform observability functionality, such as process discovery and monitoring. For example, data output 418 can represent output data generated by the edge agent for the observability pipeline system, such as collected and processed activity data for matching target processes. In some cases, data out 418 can be provided to a leader role and/or a data storage location.

The control plane communications illustrated in FIG. 4B can occur between computer node 402A and other computer nodes (e.g., 402C-402E) of observability pipeline system 400 of FIG. 4A. The data plane communications illustrated in FIG. 4B can occur between computer nodes 402A and 402B, or between computer node 402 and other computer nodes (e.g., 402C-402E) of observability pipeline system 400 of FIG. 4A.

In some instances, an edge agent on the computer node 402B may include a local user interface (UI) which is configured to provide various tools for exploring the computer node. For example, the UI of an edge agent can present system health data (e.g., uptime, load, resource usage, etc.), processes, files, and configurations on the computer node 402B. The UI of an edge agent allows editing the local configuration for the edge agent on the computer node 402B.

The user interface program on the computer node 402B includes a package through which a user of the computer node 402B can connect to other parts of the observability pipeline system 400, for example, the leader role (e.g., 402A) or another computer node with an edge agent (e.g., an edge node). When the user interface program is started, the user interface program is connected to the API socket on the computer node 402B to decide which views to display. The views then access the API socket of the computer node 402B to populate views as the user navigates around.

FIG. 5 is a block diagram showing an example of a computer system 500 that includes a data processing apparatus and one or more computer-readable storage devices. The term “data-processing apparatus” encompasses all kinds of apparatus, devices, nodes, and machines for processing data, including by way of example, a programmable processor, a computer, a system on a chip, or multiple ones, or combinations, of the foregoing, e.g., processor 510. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code), e.g., computer program 524, can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors, e.g., processor 510, executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any digital computer. Generally, a processor will receive instructions and data from a read-only memory or a random-access memory or both, e.g., memory 520. Elements of a computer can include a processor that performs actions in accordance with instructions, and one or more memory devices that store the instructions and data. A computer may also include or be operatively coupled to receive data from or transfer data to, or both, one or more mass storage devices for storing data, e.g., magnetic disks, magneto optical disks, or optical disks. However, a computer need not have such devices. Moreover, a computer can be embedded in another device, e.g., a phone, an electronic appliance, a mobile audio or video player, a game console, a Global Positioning System (GPS) receiver, or a portable storage device (e.g., a universal serial bus (USB) flash drive). Devices suitable for storing computer program instructions and data include all forms of non-volatile memory, media, and memory devices, including by way of example, semiconductor memory devices (e.g., EPROM, EEPROM, flash memory devices, and others), magnetic disks (e.g., internal hard disks, removable disks, and others), magneto optical disks, and CD ROM and DVD-ROM disks. In some cases, the processor and the memory can be supplemented by, or incorporated in, special purpose logic circuitry.

The example power unit 540 provides power to the other components of the computer system 500. For example, the other components may operate based on electrical power provided by the power unit 540 through a voltage bus or other connection. In some implementations, the power unit 540 includes a battery or a battery system, for example, a rechargeable battery. In some implementations, the power unit 540 includes an adapter (e.g., an AC adapter) that receives an external power signal (from an external source) and converts the external power signal to an internal power signal conditioned for a component of the computer system 500. The power unit 540 may include other components or operate in another manner.

To provide for interaction with a user, operations can be implemented on a computer having a display device, e.g., display 550, (e.g., a monitor, a touchscreen, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to, and receiving documents from, a device that is used by the user; for example, by sending web pages to a web browser on a user's client device in response to requests received from the web browser.

The computer system 500 may include a single computing device, or multiple computers that operate in proximity or generally remote from each other and typically interact through a communication network, e.g., via interface 530. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship between client and server may arise by virtue of computer programs running on the respective computers and having a client-server relationship to each other.

The example interface 530 may provide communication with other systems or devices. In some cases, the interface 530 includes a wireless communication interface that provides wireless communication under various wireless protocols, such as, for example, Bluetooth, Wi-Fi, Near Field Communication (NFC), GSM voice calls, SMS, EMS, or MMS messaging, wireless standards (e.g., CDMA, TDMA, PDC, WCDMA, CDMA2000, GPRS) among others. Such communication may occur, for example, through a radio-frequency transceiver or another type of component. In some cases, the interface 530 includes a wired communication interface (e.g., USB, Ethernet) that can be connected to one or more input/output devices, such as, for example, a keyboard, a pointing device, a scanner, or a networking device such as a switch or router, for example, through a network adapter.

In a general aspect, an edge-based data collection system monitors process activity in an observability pipeline system.

In a first example, a method is performed by an edge agent of an observability pipeline system, the edge agent running on a first computer node of the observability pipeline system. The method includes receiving, from a leader role running on a second computer node of the observability pipeline system, a process discovery filter configured to identify target processes running on computer nodes, the process discovery filter including a filter criteria defining an operating characteristic of target processes; selecting, by operation of the edge agent, one or more matching target processes, of a plurality of processes running on the first computer node, by applying the process discovery filter, the one or more matching target processes having respective operating characteristics that match the filter criteria; monitoring, by operation of the edge agent, activity of the one or more matching target processes, wherein monitoring the activity includes collecting activity data corresponding to monitored activity of the one or more matching target processes using one or more of the following monitoring sources: monitoring of system calls made by a respective process; monitoring via a system information kernel interface; monitoring using eBPF; and monitoring using function interposition; and processing, by operation of the edge agent, the activity data to generate output data representing the activity of the one or more matching target processes.

Implementations of the first example may include one or more of the following features. Monitoring the activity includes iteratively collecting the activity data corresponding to monitored activity, and processing the activity data to generate the output data representing the activity includes iteratively processing the activity data to generate the output data. The output data is based on activity data collected using at least two of the monitoring sources. The activity data collected using at least two of the monitoring sources corresponds to activity of a single matching target process of the one or more matching target processes. The method further includes receiving, from the leader role running on the second computer node of the observability pipeline system, an indication of the activity to monitor of the one or more matching target processes. The method further includes displaying, at the second computer node, the output data representing the activity of the one or more matching target processes.

Implementations of the first example may include one or more of the following features. The activity data corresponding to monitored activity includes one or more of the following: resource utilization of a respective target process; file system activity of a respective target process; network activity of a respective target process; application activity of a respective target process; and metadata of a respective target process.

Processing the activity data to generate output data includes formatting the activity data and causing it to be stored at a data location of the observability pipeline system. The process discovery filter is configured to identify target processes using a set of criteria based on a growth rate of resource usage by a respective target process. The resource usage includes one or more of the following: central processing unit (CPU) usage by a respective target process, memory usage by a respective target process, and file descriptor usage by a respective target process.

Implementations of the first example may include one or more of the following features. The process discovery filter is configured to identify target processes using a set of criteria based on a respective target process running a binary file identified as a binary file that has recently crashed. The process discovery filter is configured to identify target processes using a set of criteria based on a respective target process running a binary file that matches one or more attributes. The one or more attributes include one or more of the following: a path of the binary file, statistics corresponding to the binary file, an owner of the binary file, and a regular expression (regexp) of content of the binary file. The process discovery filter is configured to identify target processes using a set of criteria based on a respective target process corresponding to a program running outside of a standard installation path. The process discovery filter is configured to identify target processes using a set of criteria based on a respective target process running with an elevated privilege level. The process discovery filter is configured to identify target processes using a set of criteria based on a respective target process corresponding to a socket listening on a port identified as suspicious. The process discovery filter is configured to identify target processes using a set of criteria based on a respective target process corresponding to a higher than expected number of open files or sockets.

In a second example, a computer node includes one or more computer processors that perform one or more operations of the first example.

In a third example, a non-transitory computer-readable medium comprises instructions that are operable when executed by data processing apparatus to perform one or more operations of the first example.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple embodiments separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

What is claimed is:

1. A method performed by an edge agent of an observability pipeline system, the edge agent running on a first computer node of the observability pipeline system, the method comprising:
receiving, from a leader role running on a second computer node of the observability pipeline system, a process discovery filter configured to identify target processes running on computer nodes, the process discovery filter including a filter criteria defining an operating characteristic of target processes;
selecting, by operation of the edge agent, one or more matching target processes, of a plurality of processes running on the first computer node, by applying the process discovery filter, the one or more matching target processes having respective operating characteristics that match the filter criteria;
monitoring, by operation of the edge agent, activity of the one or more matching target processes, wherein monitoring the activity includes collecting activity data corresponding to monitored activity of the one or more matching target processes using one or more of the following monitoring sources:
monitoring of system calls made by a respective process;
monitoring via a system information kernel interface;
monitoring using eBPF; and
monitoring using function interposition; and
processing, by operation of the edge agent, the activity data to generate output data representing the activity of the one or more matching target processes.

2. The method of claim 1, wherein:
monitoring the activity includes iteratively collecting the activity data corresponding to monitored activity, and
processing the activity data to generate the output data representing the activity includes iteratively processing the activity data to generate the output data.

3. The method of claim 1, wherein the output data is based on activity data collected using at least two of the monitoring sources.

4. The method of claim 3, wherein the activity data collected using at least two of the monitoring sources corresponds to activity of a single matching target process of the one or more matching target processes.

5. The method of claim 1, comprising receiving, from the leader role running on the second computer node of the observability pipeline system, an indication of the activity to monitor of the one or more matching target processes.

6. The method of claim 1, wherein the activity data corresponding to monitored activity includes one or more of the following:
resource utilization of a respective target process;
file system activity of a respective target process;
network activity of a respective target process;
application activity of a respective target process; and
metadata of a respective target process.

7. The method of claim 1, wherein processing the activity data to generate output data includes formatting the activity data and causing it to be stored at a data location of the observability pipeline system.

8. The method of claim 1, wherein the process discovery filter is configured to identify target processes using a set of criteria based on a growth rate of resource usage by a respective target process.

9. The method of claim 8, wherein the resource usage includes one or more of the following:
central processing unit (CPU) usage by a respective target process,
memory usage by a respective target process, and
file descriptor usage by a respective target process.

10. The method of claim 1, wherein the process discovery filter is configured to identify target processes using a set of criteria based on a respective target process running a binary file identified as a binary file that has recently crashed.

11. The method of claim 1, wherein the process discovery filter is configured to identify target processes using a set of criteria based on a respective target process running a binary file that matches one or more attributes.

12. The method of claim 11, wherein the one or more attributes include one or more of the following:
a path of the binary file,
statistics corresponding to the binary file,
an owner of the binary file, and
a regular expression (regexp) of content of the binary file.

13. The method of claim 1, wherein the process discovery filter is configured to identify target processes using a set of criteria based on a respective target process corresponding to a program running outside of a standard installation path.

14. The method of claim 1, wherein the process discovery filter is configured to identify target processes using a set of criteria based on a respective target process running with an elevated privilege level.

15. The method of claim 1, wherein the process discovery filter is configured to identify target processes using a set of criteria based on a respective target process corresponding to a socket listening on a port identified as suspicious.

16. The method of claim 1, wherein the process discovery filter is configured to identify target processes using a set of criteria based on a respective target process corresponding to a higher than expected number of open files or sockets.

17. The method of claim 1, comprising displaying, at the second computer node, the output data representing the activity of the one or more matching target processes.

18. A computer node comprising:
one or more processors; and
memory storing instructions that, when executed by the one or more processors, cause the one or more processors to perform operations of an edge agent of an observability pipeline system, the operations comprising:
receiving, from a leader role running on a second computer node of the observability pipeline system, a process discovery filter configured to identify target processes running on computer nodes, the process discovery filter including a filter criteria defining an operating characteristic of target processes;
selecting, by operation of the edge agent, one or more matching target processes, of a plurality of processes running on the first computer node, by applying the process discovery filter, the one or more matching target processes having respective operating characteristics that match the filter criteria;
monitoring, by operation of the edge agent, activity of the one or more matching target processes, wherein monitoring the activity includes collecting activity data corresponding to monitored activity of the one or more matching target processes using one or more of the following monitoring sources:
monitoring of system calls made by a respective process;
monitoring via a system information kernel interface;
monitoring using eBPF; and
monitoring using function interposition; and
processing, by operation of the edge agent, the activity data to generate output data representing the activity of the one or more matching target processes.

19. The computer node of claim 18, wherein:
monitoring the activity includes iteratively collecting the activity data corresponding to monitored activity, and
processing the activity data to generate the output data representing the activity includes iteratively processing the activity data to generate the output data.

20. The computer node of claim 18, wherein the output data is based on activity data collected using at least two of the monitoring sources.

21. The computer node of claim 20, wherein the activity data collected using at least two of the monitoring sources corresponds to activity of a single matching target process of the one or more matching target processes.

22. The computer node of claim 18, the operations comprising receiving, from the leader role running on the second computer node of the observability pipeline system, an indication of the activity to monitor of the one or more matching target processes.

23. The computer node of claim 18, wherein the activity data corresponding to monitored activity includes one or more of the following:
resource utilization of a respective target process;
file system activity of a respective target process;
network activity of a respective target process;
application activity of a respective target process; and
metadata of a respective target process.

24. A non-transitory computer-readable medium storing instructions that perform operations of an edge agent of an observability pipeline system when executed by data processing apparatus of a computer node, the operations comprising:
receiving, from a leader role running on a second computer node of the observability pipeline system, a process discovery filter configured to identify target processes running on computer nodes, the process discovery filter including a filter criteria defining an operating characteristic of target processes;
selecting, by operation of the edge agent, one or more matching target processes, of a plurality of processes running on the first computer node, by applying the process discovery filter, the one or more matching target processes having respective operating characteristics that match the filter criteria;
monitoring, by operation of the edge agent, activity of the one or more matching target processes, wherein monitoring the activity includes collecting activity data corresponding to monitored activity of the one or more matching target processes using one or more of the following monitoring sources:
monitoring of system calls made by a respective process;
monitoring via a system information kernel interface;
monitoring using eBPF; and
monitoring using function interposition; and
processing, by operation of the edge agent, the activity data to generate output data representing the activity of the one or more matching target processes.
